(19) United States
(12) Patent Application Publication
(10) Pub. No.: US 2024/0426328 A1
(43) Pub. Date: Dec. 26, 2024

(54) DEVICE FOR CLAMPING AN OBJECT COMPRISING A BELT

(71) Applicant: CAILLAU, ROMORANTIN-LANTHENY (FR)

(72) Inventors: Martial BLANCHET, ROMORANTIN-LANTHENAY (FR); Leny IBANEZ, MARCILLY EN GAULT (FR)

(21) Appl. No.: 18/748,125

(22) Filed: Jun. 20, 2024

(30) Foreign Application Priority Data
Jun. 21, 2023 (FR) 2306425

(51) Int. Cl. F16B 2/08

(52) U.S. Cl. CPC F16B 2/08

(57) ABSTRACT

The clamping device comprises a belt with at least a first and a second clamping end and a clamping member which connects the two clamping ends while being retained relative to them so that the clamping of the clamping member moves the first and second clamping ends relative to each other by clamping the belt. The clamping member is retained relative to at least the first clamping end via a spring and a connecting piece, so that the clamping of the clamping member tends to move the connecting piece relative to the first clamping end against the elastic return of the spring. The connecting piece is able to occupy, relative to the first clamping end, a waiting position in which it holds the spring with respect to the first clamping end.

### BACKGROUND

The present disclosure relates to a clamping device comprising a clamping belt for clamping an object.

It is particularly a clamping device for clamping an object which may experience expansions while the clamping must be held. Particularly, this object can be a hydrogen tank and the clamping device makes it possible to hold this tank clamped and to fix it to a support such as a part of the chassis of a vehicle. A hydrogen tank experiences significant expansions. Indeed, the filling pressure of such a tank traditionally reaches several hundred bars, for example from 350 to 750 bars. Such a tank can be made of various materials, for example a composite material possibly reinforced with fibers such as carbon fibers. The very high filling pressures cause this tank to expand while it retracts as its inner pressure decreases when the hydrogen is consumed.

In general, the clamping device according to the disclosure can be used to clamp other objects which may experience an expansion, but for which it is important to hold the clamping as it expands.

The object in question can particularly be cylindrical in shape, or at least include a clamping portion in which it has symmetry of revolution. The clamping device comprises a belt which is clamped on the clamping portion of this object. The clamped belt must be able to accompany the expansions of this object, that is to say its diametrical dimensions must be able to increase or decrease while maintaining the clamping force.

To this end, the clamping device can comprise a spring. To clamp this object, the belt must be placed around the clamping portion of said object, and be able to be clamped in this situation. The forces involved during this placement and clamping can be significant, due to the reaction forces exerted by the object on the belt and to the return forces exerted by the spring, against the clamping force. Thus, it may be difficult to mount and/or position the belt around the object and to clamp it while correctly holding this belt and this spring.

### SUMMARY

The present disclosure relates to a clamping device comprising a clamping belt, a clamping member which moves ends of the belt relative to each other to clamp the belt, and a spring serving to maintain the clamping force exerted by the belt, despite the possible expansions of the object clamped by the device.

The disclosure aims to propose such a clamping device whose placement on the object to be clamped and clamping around this object can be carried out in a simple manner, particularly without risking losing the spring or carrying out complex manipulations to hold it in place before and during the clamping.

Thus, according to a first aspect, the disclosure relates to a device for clamping an object, comprising a belt with at least a first and a second clamping end and a clamping member which connects the two clamping ends while being retained relative to them so that the clamping of the clamping member moves the first and second clamping ends relative to each other so as to tighten the belt, the clamping member being retained relative to at least the first clamping end via a spring and a connecting piece, so that the clamping of the clamping member tends to move the connecting piece relative to the first clamping end against the elastic return of the spring, the connecting piece being able to occupy, relative to the first clamping end, a waiting position in which it holds the spring with respect to the first clamping end.

The belt is tightened by moving the first and second clamping ends relative to each other through the clamping of the clamping member, that is to say through the activation or the actuation of the latter in the direction of the clamping. However, this clamping member is retained relative to the first end of the belt via the spring and the connecting piece, so that the clamping of the clamping member has the effect of moving the connecting piece relative to the first clamping end against the elastic return of the spring. More specifically, the clamping of the clamping member moves the spring which, subject to its elastic deformation, drives the first clamping end so that it moves relative to the second clamping end, and this movement of the spring also causes that of the connecting piece.

It is therefore understood that, when the clamping member cooperates with the first and second ends to clamp them, it tends to move the first end by first exerting a force on the spring. For example, if this spring works in compression, the clamping is exerted on the connecting piece which tends to compress the spring and, when the satisfactory compression level is reached, it causes the movement of the first clamping end relative to the second clamping end. It is therefore understood that the spring allows, depending on its compression level, maintaining the clamping by ensuring the proper positioning of the second clamping end of the belt relative to the first one.

However, before the clamping, the connecting piece occupies its waiting position in which it holds the spring with respect to the first clamping end. Thus, the spring is pre-mounted at the first end of the belt while being correctly held relative to the connecting piece. The clamping device can therefore be placed around the object to be clamped without risking losing the spring or without having to manipulate it. Once the clamping device has been placed on the object to be clamped, the clamping can be carried out by the clamping member.

Optionally, the device comprises a member for holding the connecting piece in the waiting position, particularly a waiting clipping member.

Optionally, the connecting piece is able to occupy a clamping threshold position which is reached by the clamping of the clamping member.

Optionally, the device comprises a threshold mark to note that the clamping threshold position has been reached, the threshold mark particularly comprising a threshold clipping member.

Optionally, the connecting piece is configured to occupy a maximum clamping limit position, the device optionally comprising a maximum clamping stop.

Optionally, the connecting piece forms a cage part in which the spring is disposed, the connecting piece optionally having a portion for centering the spring.

Optionally, the clamping member comprises a clamping rod and the cage part formed by the connecting piece has a retaining surface against which an element for retaining the clamping rod, such as a head of said rod, is retained, said retaining surface optionally comprising an anti-rotation member of the clamping rod and being optionally located on an outer face of the spring centering portion.

Optionally, the connecting piece has a U shape with two branches, the connecting piece being plugged onto the first clamping end so that this first clamping end passes between the two branches, the member for holding the connecting piece in the waiting position comprising at least one holding protrusion protruding on the inner face of at least one of the two branches.

Optionally, the connecting piece has a U shape with two branches, the connecting piece being plugged onto the first clamping end so that this first clamping end passes between the two branches, the threshold mark comprising a mark protrusion protruding on the inner face of at least one of the two branches.

Optionally, the connecting piece has a U shape with two branches, the connecting piece being plugged onto the first clamping end so that this first clamping end passes between the two branches, at least one of the two branches having a maximum clamping stop protrusion.

Optionally, the clamping member comprises a clamping rod which is retained relative to the second clamping end of the belt by a nut.

Optionally, the belt comprises a first belt part whose first end forms one of the first and second clamping ends and a second belt part whose first end forms the other of the first and second clamping ends, said second belt part forming a fixing part configured to be fixed on a support.

Optionally, the belt comprises a first belt part whose first end forms one of the first and second clamping ends and a second belt part whose first end forms the other of the first and second clamping ends, the second ends of the first and second belt parts being connected by a hinge.

Optionally, the second end of the second belt part has a retaining area, relative to which the second end of the first belt part is pivotally retained by a pivot axis, the retaining area particularly comprising a slot into which the second end of the first belt part is inserted.

Optionally, the first belt part has a twist area bringing the second end of the first belt part substantially at right angles to a current part of the first belt part, the pivot axis being perpendicular to said second end of the first belt part, particularly by being engaged in a drilling of the second end of the first belt part, this drilling optionally having a flange.

Optionally, the second end of the first belt part has a longitudinal fold according to which two band halves of the first belt part are brought against each other, by being optionally kept pressed against each other, for example by welding or clinching.

Optionally, the first belt part has a boss located on the other side of the twist area relative to the second end of the first belt part.

Optionally, the second end of the first belt part has two parallel legs each inserted into a slot in the retaining area.

Optionally, the two legs are separated by a cutout and the second end of the first belt part has a twist area comprising two twists bringing each of the legs substantially at right angles to a current part of the first belt part.

The disclosure also aims to propose a clamping device which comprises a belt with two belt parts hinged relative to each other. It then involves proposing a simple hinge easy to implement, and capable of withstanding significant tensile forces, particularly when the clamping device is used to apply significant clamping forces, for example of the order of 300 to 800 dN, in particular when the clamping device is used to clamp an object of the hydrogen tank type.

According to a second aspect, the disclosure also relates to a device for clamping an object, comprising a belt comprising a first belt part whose first end forms a first clamping end and a second belt part whose first end forms a second clamping end, the first ends of the first and second belt parts can be moved relative to each other to tighten the belt, the first belt part having a twist area bringing the second end of the first belt part substantially at right angles to a current part of the first belt part, and the second end of the second belt part having a retaining area, relative to which the second end of the first belt part is pivotally retained by a pivot axis perpendicular to said second end of the first belt part, particularly by being engaged in a drilling of the second end of the first belt part.

The inner periphery of the belt generally defines a cylindrical surface or a cylindrical clamping surface portion parallel to which the current part of the belt, particularly the current part of the first belt part, is oriented. However, due to the twist of the first belt part, the second end of this first part is brought at a right angle to this current part, which allows it to easily cooperate with the retaining area of the second end of the second belt part by retaining it relative to it by the pivot axis perpendicular to the second end of the first belt part. When, particularly, the axis is engaged in a drilling of the second end of the first belt part, the cooperation between the pivot axis and this first belt part can withstand significant forces, while the structure and the manufacture of the belt can be particularly simple and require little material.

Optionally, according to the second aspect, the retaining area comprises a slot into which the second end of the first belt part is inserted, so that the pivot axis is located on the other side of the slot relative to the current part of the first belt part.

Optionally, according to the second aspect, the second end of the first belt part has a longitudinal fold according to which two band halves of the first belt part are brought against each other, by being optionally kept pressed against each other, for example by welding or clinching.

Optionally, according to the second aspect, the first belt part has a boss located on the other side of the twist area relative to the second end of the first belt part.

Optionally, according to the second aspect, the second end of the first belt part has two parallel legs each inserted into a slot of the retaining area.

Optionally, according to the second aspect, the two legs are separated by a cutout and the second end of the first belt part has a twist area comprising two twists bringing each of the legs substantially at right angles to a current part of the first belt part.

### BRIEF DESCRIPTION OF THE DRAWINGS

The disclosure will be well understood and its advantages will appear better upon reading the following detailed description of embodiments represented by way of non-limiting examples. The description refers to the attached drawings in which:

FIG. 1 is a perspective view of the clamping device according to the present disclosure.

FIG. 2 is a front view of the device of FIG. 1.

FIG. 3 is an exploded perspective view showing several components or parts of components of the device according to the present disclosure.

FIG. 4 is a perspective view of the device according to the present disclosure, with an enlargement in the clamping area, the connecting piece being in its waiting position.

FIG. 5 is a side view of the connecting piece.

FIG. 6 is a perspective view of the device, showing enlargements in the clamping area and in a hinge area, the connecting piece being represented in a clamping threshold position.

FIG. 7 is a perspective view of the device, with an enlargement in the clamping area, the connecting piece being represented in the clamping threshold position.

FIG. 8 is a perspective view of the device, with enlargements in the clamping area and in the hinge area.

FIG. 9 is a perspective view showing part of the clamping device according to one variant of embodiment.

FIG. 10 shows in perspective the connecting piece according to one variant.

FIG. 11 illustrates another variant for the connecting piece.

FIG. 12 shows in perspective a variant for the configuration of the hinge area.

FIG. 13 shows the same variant as FIG. 12, from another angle of view.

### DETAILED DESCRIPTION

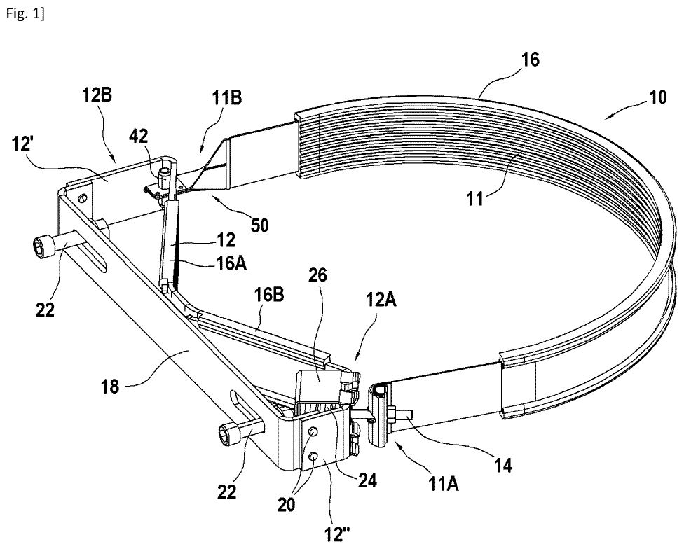

The device represented in FIG. 1 comprises a belt 10 which, in this case, comprises a first belt part 11 and a second belt part 12 connected to each other. The belt has a first clamping end 12A which, in this case, is formed by one end of the second belt part 12, and a second clamping end 11A which, in this case, is formed by one end of the first belt part 11. Of course, the first and second clamping ends could be reversed.

Within the meaning of the present disclosure, unless otherwise specified, the elements qualified as inner or internal are those that are disposed on the inner side of the belt, that is to say in the annular space delimited by the belt, while the outer or external elements are those that are disposed on the opposite side. Likewise, unless otherwise specified, it will be considered that an element will be qualified as “inner” relative to another element called “outer” when the inner element will be closer to the interior of the belt or the axis of the latter, than the outer element. Here, the axis of the belt can be defined by the axis of a circle circumscribed to the belt.

A clamping member 14 connects the two clamping ends 11A and 12A. In this case, the belt parts 11 and 12 are connected by a hinge to their respective second ends 11B and 12B. It is seen that, when assembled, the two belt parts define therebetween an inner contour capable of receiving an object to be clamped by the device, particularly a clamping portion of such an object which can for example be a hydrogen tank. Thus, the device can clamp a cylindrical part of revolution or, in general, a shape that can be surrounded by the belt.

Generally, the different constituent elements of the device are made of metal. This is particularly the case with the belt. However, clamping contact parts, which can be in contact with the object to be clamped by exerting a clamping pressure on the latter, can be coated with a material such as an elastomeric material of the EPDM (ethylene-propylene-diene monomer) type. It is thus seen that a current part of the belt part 11 is covered, on its inner face, with a sheath 16 and that, similarly, the second belt part 12 has contact parts with the object to be clamped also covered with sheaths 16A, 16B on their inner faces. The sheaths provide contact surfaces between the device and the clamped object which are not harmful to this object. In addition, they can have non-slip properties, for example by being ridged as in the example represented. These sheaths can locally cover all the faces of the belt portion concerned or, as in the example represented, only cover the inner face while being secured to the belt by any means, for example by grooves on the sides of the sheath, in which the edges of the belt are to be clamped.

In this case, the first belt part 11 forms a strapping part, while having a contour in the form of a cylinder portion of revolution, to come into clamping bearing against the cylindrical surface of the object to be clamped. For its part, the second belt part in this case forms a fixing part which is configured to be fixed on a support. In fact, this second belt part 12 is in this case mounted on a support part 18, to which it is for example connected by screws, rivets or weld points 20, by its connecting branches 12′ and 12″. This support part 18 can form a support strip or bracket or the like, fixed to a support element such as a part of a vehicle or of a vehicle chassis by any appropriate means, for example by fixing legs or screws 22. In this case, the second belt part 12 is fixed to the support 18 and to this end has side wings 12′ and 12″ which are folded in a direction moving away from the inner periphery of the belt in order to be fixed to fixing areas of the support 18.

In this case, the second belt part 12 has a generally V shape, the branches of the V forming bearing portions on the object to be clamped. It is on these branches that the sheaths 16A and 16B are disposed.

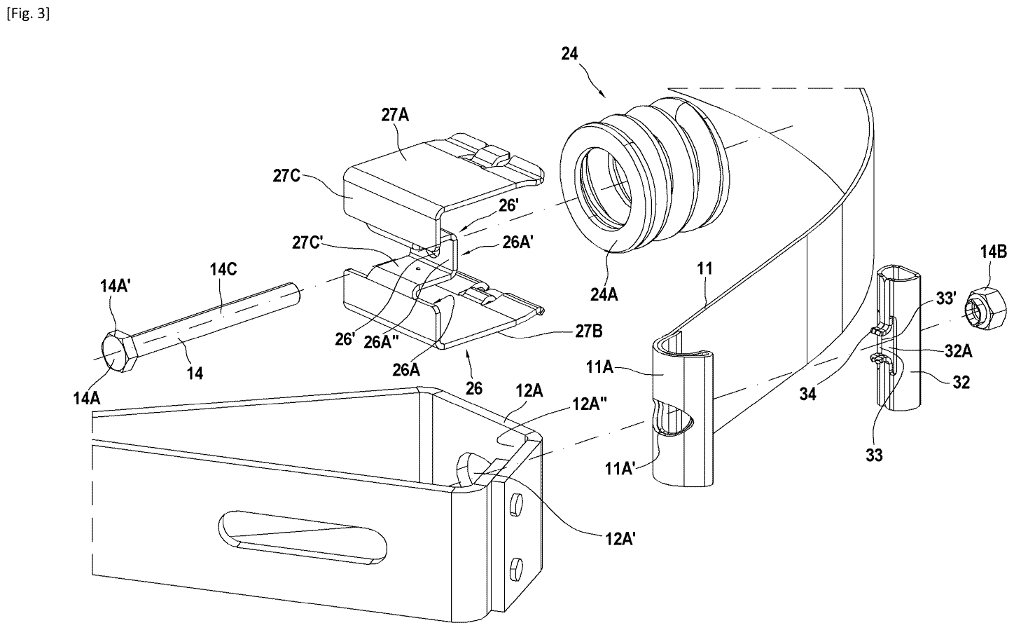

As seen in particular in FIG. 3, the clamping member comprises a clamping rod, for example a screw 14, which is retained relative to the first clamping end 12A by a retaining member such as a head 14A of the screw, and which is retained at the second clamping end 11A by a retaining member such as a nut 14B. The rod 14C of the screw passes through drillings of the clamping ends, namely a drilling 12A′ of the first clamping end 12A and a drilling 11A′ of the second clamping end 11A (see FIG. 3).

Of course, it could be possible to reverse the head 14A and the nut 14B, or provide that the clamping rod is a threaded rod at its two ends, cooperating at each of these ends with a nut. It could also be possible to design a different clamping member, cooperating respectively with the two clamping ends and capable of being actuated to move them from each other in order to clamp the collar by other clamping means than the screwing.

It is seen in particular in FIGS. 1 and 3 that the clamping member 14 is retained relative to the first clamping end 12A via a spring 24 and a connecting piece 26. It is understood that, for tightening the belt around the object to be clamped, the clamping of the clamping member tends to move the connecting piece 26 relative to the first clamping end 12A against the elastic return effect of the spring 24. This is in this case a compression spring which is disposed between an outer face 12A″ of the first clamping end and an inner face 26A of a bottom wall 27C of the connecting piece 26 which is opposite to the outer face 12A″.

In this case, the connecting piece 26 forms a cage part in which the spring 24 is disposed. Particularly, the spring is held between the aforementioned bottom wall 27C and the side walls 27A and 27B of this connecting piece.

It is also seen in FIG. 3 that the connecting piece 26 comprises a portion for centering the spring 24. In this case, the spring 24 is a helical spring and the bottom wall 27C of the connecting piece 26 has an advanced central portion 26A′ which is configured to be engaged in the end 24A of the spring and thus forms a portion for centering the spring. A space for housing the turns of the spring is arranged between the advanced portion 26A′ and the inner faces, that is to say turned towards each other, of the side walls 27A and 27B.

The cage formed by the connecting piece has an outer retaining surface which, in this case, is formed on the external face 26A″ of the advanced portion 26A′, this external face is the one that is opposite to the spring 24. The bottom wall 27C has a drilling 26′ allowing the passage of the barrel 14C of the clamping rod 14. The outer face of the bottom wall 27C forms, around the drilling 26′, a means for retaining the head 14A of the rod 14 or of a nut cooperating with this rod.

The connecting piece 26 also includes an anti-rotation member making it possible to prevent the rotation of the clamping rod 14 relative to this piece. In this case, the anti-rotation member is formed by a part 27C′ of the outer retaining surface. Indeed, the clamping head 14A may have one or several flats 14A′, for example by being hexagonal or square. For its part, the outer retaining surface 26A″ may have edges 27C′ forming flats cooperating with the flat(s) of the head of the clamping rod to block the latter in rotation. In this case, the advanced portion 26A′ of the bottom wall 27C has axial wall elements 27C′ which extend parallel to the axis of the clamping rod 14, towards the first clamping end 12A. The outer faces of these wall elements cooperate with the flats of the head of the clamping rod to lock it in rotation.

Depending on the dimensions of the spring and those of the clamping rod, the advanced portion can have a shape giving it, in a first direction, dimensions adapted to those of the spring so that the advanced portion is engaged in the spring by wedging it transversely and giving it, in a second direction and on its opposite face, dimensions adapted to wedge the head of the clamping rod. For example, the advanced portion may be rectangular and have a length, on its face turned towards the spring, adapted to the inner transverse dimensions of the spring and have a width, on its inner face receiving the head of the clamping rod, which locks the latter in rotation.

Alternatively or complementarily, it is possible to ensure that the head 14A of the clamping rod is forcefully engaged in the well formed by the advanced portion 26A′, on the side opposite to the first clamping end 12A, which allows not only to lock it in rotation, but also to retain it axially when placing the spring and mounting the connecting piece and the spring on the first clamping end 12A.

Generally, the connecting piece 26 has in this case a U shape with two branches forming the side walls 27A and 27B previously mentioned, and a bottom forming the bottom wall 27C. In this case, this bottom wall itself has an advanced portion 26A′ as indicated. The width of the connecting piece, measured transversely to the axial direction of the clamping rod, is smaller in the region of the advanced portion 26A′ than in the branches 27A and 27B, and in the portion of the bottom wall 27C which is not advanced. This allows the advanced portion 26A′ to be housed inside the turns of the spring 24, while ensuring that the spring is protected laterally over its entire or almost its entire width, by the side walls 27A and 27B forming the branches of the U.

Due to its U shape, the connecting piece 26 can be plugged onto the first clamping end 12A so that this first clamping end passes between the two branches 27A and 27B.

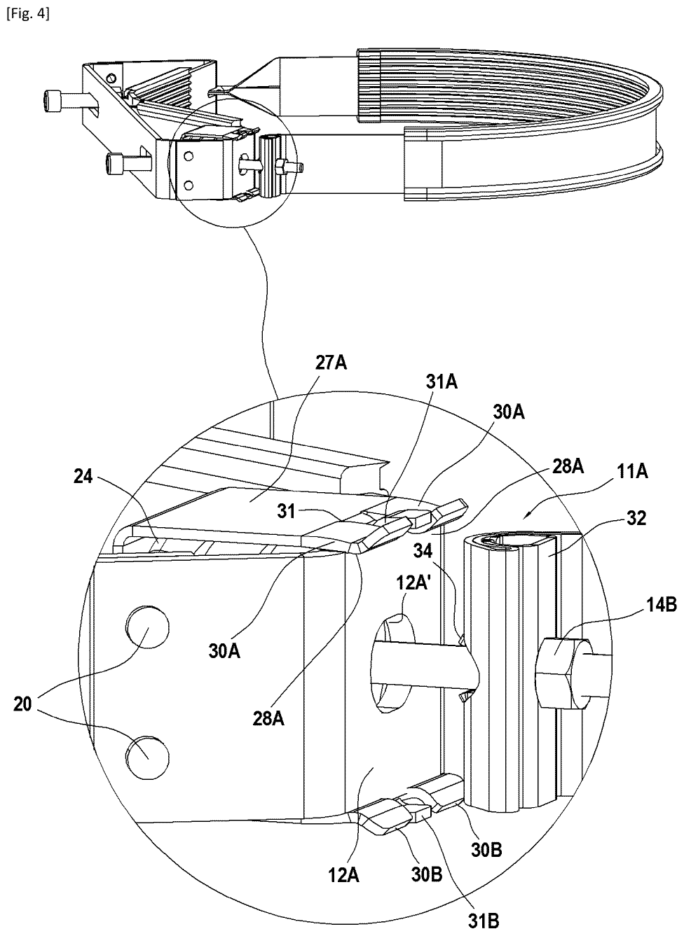

FIG. 4 shows the connecting piece in a waiting position in which it holds the spring 24 with respect to the first clamping end 12A, before the clamping. Thus, in this situation, the belt 10 can be disposed around the object to be clamped while having completely spaced the clamping rod 14 apart from the rest of the device, the assembly formed by the first end 12A of the belt, the connecting piece 26 and the spring 24 forming a homogeneous whole which remains assembled during the various manipulations carried out. However, this pre-mounting of the spring then does not oppose the movement of the connecting piece relative to the first end of the belt during the clamping.

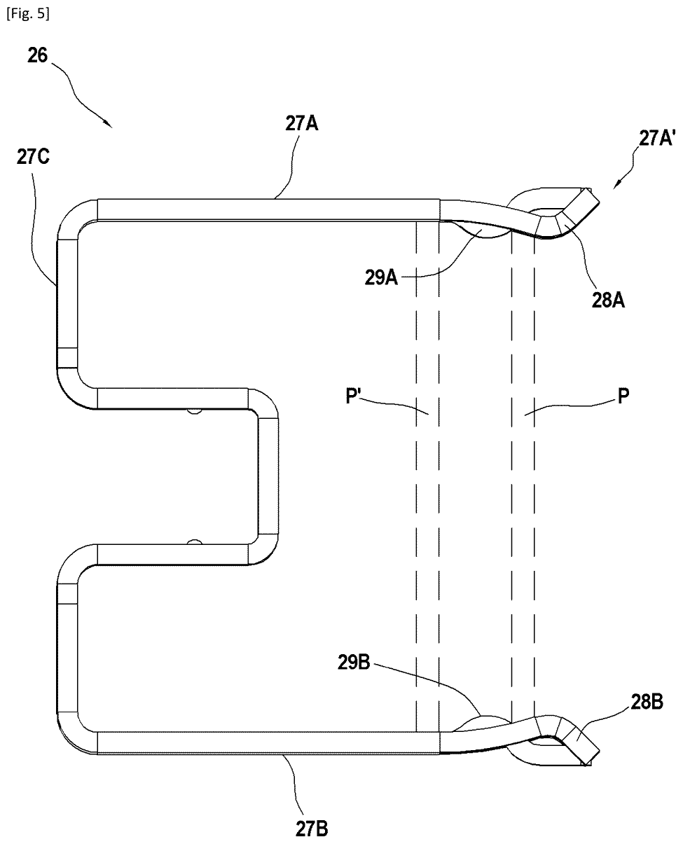

To hold the connecting piece 26 in the waiting position, the device may comprise a member for holding in the waiting position, particularly a waiting clipping member. This member makes it possible to clip or pre-hook the connecting piece on the first clamping end 12A. In this case, the member for holding the connecting piece in the waiting position is formed on the side walls 27A and 27B of the connecting piece. It is seen indeed, looking particularly at FIGS. 4 and 5, that, on the side opposite to the bottom wall 27C, these side walls have inner hooking protrusions, inner protrusions carried by one of the walls, for example the wall 27A, projecting towards the other wall, for example the wall 27B. Here, “inner” means on the internal side of the U formed by the connecting piece.

Thus, the side wall 27A comprises a first inner protrusion 28A and a second inner protrusion 29A offset from each other in the axial direction, which here is the direction of the axis of the spring and the axis of the clamping rod. In this case, the inner protrusion 28A is closer to the free end 27A′ of the side wall opposite to the bottom 27C than the protrusion 29A. In this case, these protrusions are formed by corrugations protruding inwardly of the clamping piece. In this case, as seen in FIG. 4, the terminal portions of the side walls 27A and 27B opposite to the bottom 27C have axial cutouts between which legs which have inward corrugations forming the protrusions 28A and 29A cited above are thus arranged. For example, the free end portion of the side wall 27A has two marginal legs 30A between which an intermediate leg 31A is made. This intermediate leg 31A is only separated from the marginal legs 30A by longitudinal cutouts 31. The marginal legs 30A have inward corrugations which form the protrusions 28A and, at their free ends, are curved outwards. The intermediate leg 31A also has an inward corrugation 29A and is also curved outwards between this corrugation and its free end. The peaks of the corrugations 28A are disposed on the same transverse line, perpendicular to the direction of the axis of the spring and are closer to the free end of the side wall 27A than that of the corrugation 29A. The configuration of the connecting piece 26 is symmetrical, and it is seen that the other side wall 27B has protrusions 28B and 29B forming corrugations, similar to the corrugations 28A and 29A, these corrugations 28B and 29B being formed in outer legs 30B and an intermediate leg 31B which extends between these outer legs 30B.

When plugging the connecting piece onto the first clamping end 12A, the corrugations 28A and 28B form hard points which must be exceeded to achieve the plugging. Once these hard points are exceeded, the first clamping end 12A formed here by a band portion occupies the position P indicated in FIG. 5. It is understood that, in this situation, the connecting piece 26 is retained on this first end 12A with respect to an axial movement, that is to say along the axis of the spring 24, through its location between, on the one hand, the corrugations 28A and 28B and, on the other hand, the corrugations 29A and 29B. A stable waiting position in which the connecting piece 26 can be held is thus obtained. In FIG. 5, to facilitate the visibility, the spring 24 has not been represented, but it goes without saying that it is then held in the connecting piece 26, particularly then by abutting against, on the other hand, the outer face 12A″ of the first clamping end 12A (see FIG. 3) and, on the other hand, the inner face 26A of the bottom wall 27C of the clamping piece 26.

As indicated, the waiting position allows the spring 24 to be held at the first clamping end 12A. It also allows the clamping device to be manipulated in order to be disposed around the object to be clamped, even before the clamping member is in place and, in any case, before it is clamped. During these manipulations, the assembly formed by the connecting piece 26 and the spring 24 remains pre-mounted at the first clamping end 12A.

In this case, the connecting piece 26 is also able to occupy a clamping threshold position which is reached by the clamping of the clamping member. Thus, the connecting piece is in its waiting position during the mounting and closing of the belt around the object to be clamped, then, during the clamping, it moves from its waiting position to its threshold clamping position under the effect of clamping of the clamping member.

The device can comprise a threshold mark to note that the clamping threshold position is reached. In this case, this threshold mark is formed by the corrugation(s) 29A and 29B previously mentioned, which form hard points during the clamping and which must be exceeded for the effective clamping phase to be reached. Here, “exceeded” means that, during the clamping, the connecting piece 26 moves on the first clamping end 12A so that this first end reaches more its bottom wall 27C relative to the corrugations 29A and 29B.

These corrugations 29A and 29B form threshold clipping members, since their exceeding during the clamping is similar to a clipping or a snapping. This threshold mark can be visible by the fact that, when it is crossed, the intermediate legs 31A and 31B on which the corrugations 29A and 29B are formed tend to move apart from each other. This constitutes a visual mark for the fitter, who can also easily visualize the fact that the first end 12A has actually exceeded the corrugations 29A and 29B.

From the moment the threshold mark has been exceeded, the clamping can be carried out up to the desired clamping level and by taking into account the stiffness of the spring and of its level of stress (compression rate for a compression spring like in the example represented). This threshold mark, in particular when it takes the form of a visual mark, is a simple and reliable way to ensure that the desired clamping level is reached. This is an objective mark, it being noted that it is sometimes inaccurate to rely on the clamping torque reached by the tool used for the clamping because the measurement of this torque can be distorted by extraneous parameters at the actual clamping level obtained, such as possible friction of the clamping rod against the pieces with which it cooperates and the coefficient of friction of the screwing elements (threads of the rod and of the nut). The threshold mark can also be disposed so that it is considered that, once it is exceeded, the desired clamping value has been obtained.

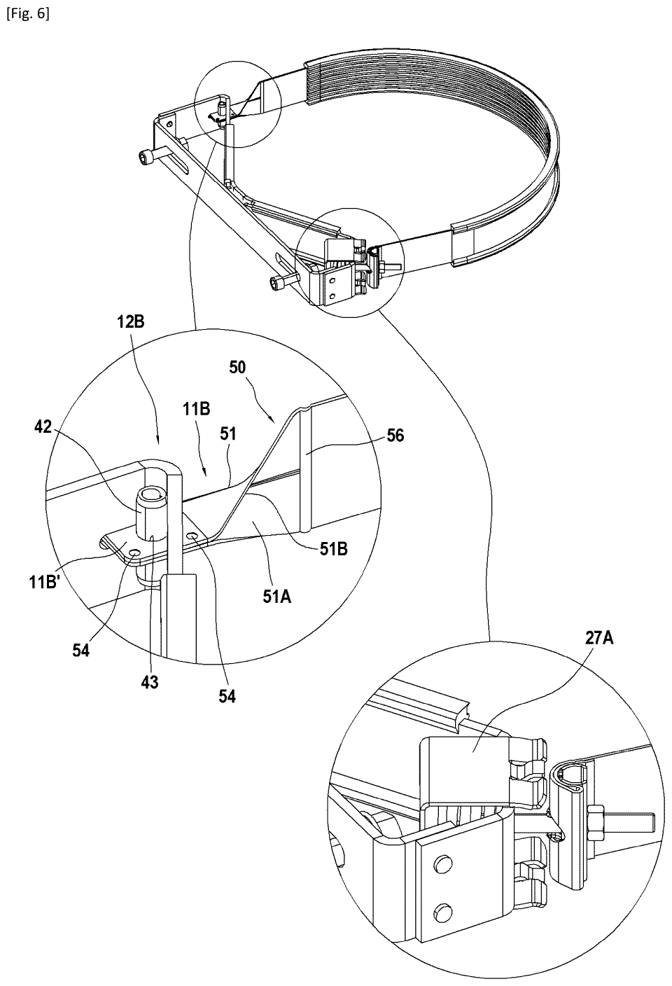

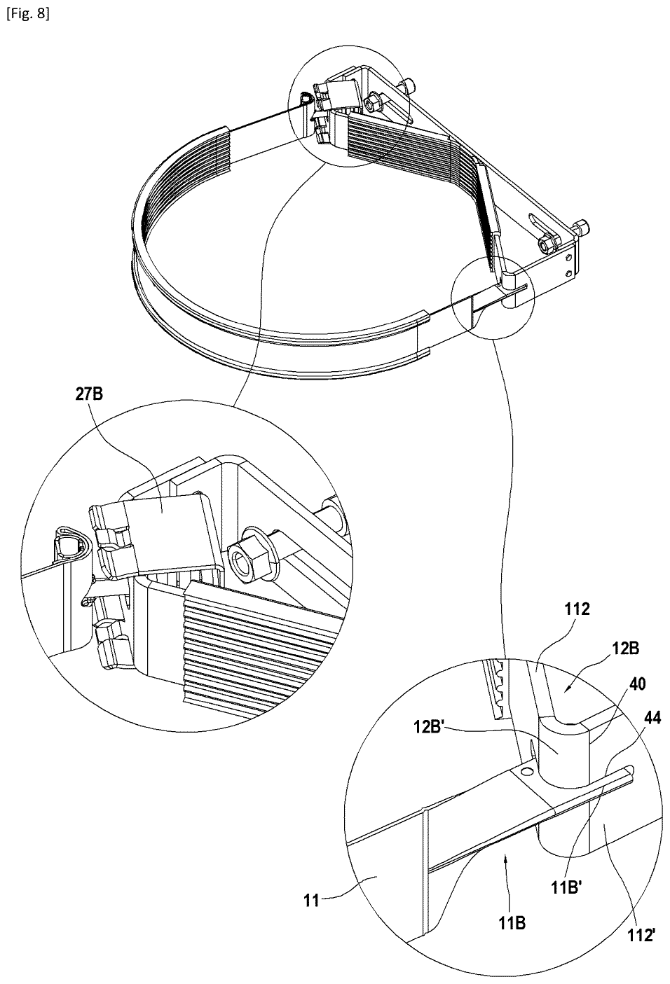

Once the threshold mark is exceeded and the clamping device is thus clamped around the object, this device can accompany any expansions of the object it is clamping because these expansions cause a movement of the connecting piece 26 relative to the first clamping end 12A, against the elastic return effect of the spring 24. The clamping threshold is exceeded in FIGS. 6 and 8, in which the first clamping end occupies the position P′ indicated in FIG. 4.

For example, when this object is a hydrogen tank, the clamping device can be placed while this tank is empty or practically empty, then this tank can be filled up to the desired nominal position, which as indicated previously, can reach several hundred bars, whereupon it expands and then stresses the elastic clamping return allowed by the presence of the spring 24.

As a variant, it can be provided that the connecting piece 26 is able to occupy a maximum clamping limit position. This avoids stressing the different elements of the clamping device and particularly the spring 24, beyond their elastic limit. In other words, this makes it possible to avoid plastic deformations that would harm the durability of the clamping.

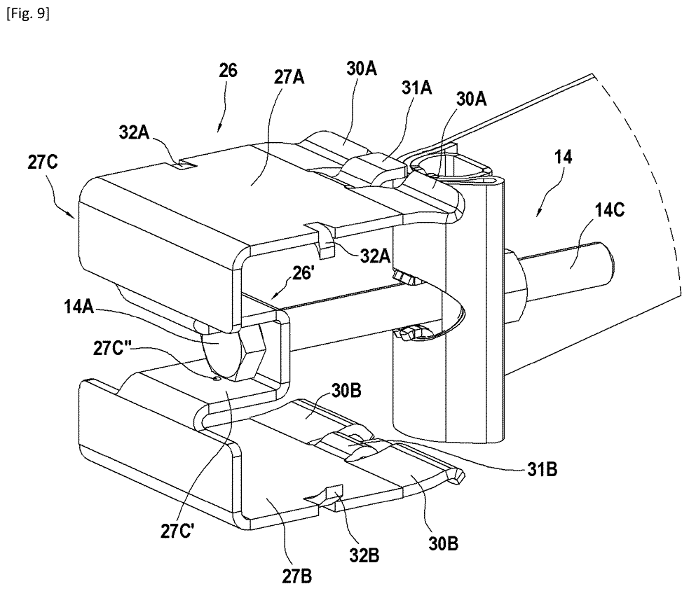

The variant in FIG. 9 illustrates this possibility. It is seen in this figure that the connecting piece 26 comprises, in addition to the different elements or components mentioned above, maximum clamping stops 32A and 32B. In this case, these maximum clamping stops are formed by protrusions inwardly of the side walls 27A and 27B. In this case, these are tabs cut into the longitudinal edges of these side walls and folded inwards (the interior here meaning the interior of the U formed by the clamping piece). Being formed on the edges of the side walls, these inner protrusions do not interfere with the spring 24. On the other hand, they are capable of abutting against the outer face of the first clamping end 12A of the belt in the maximum clamping position.

FIG. 9 also shows the presence, on the side wall element 27C′ of the advanced portion 26A′ of the connecting piece, of a non-return element 27C″ allowing, once the head 14A of the clamping rod 14 has reached the position, at the bottom of the outer face of the advanced portion, to oppose an extraction of the screw. In a way, this non-return element 27C″ forms a clipping member which must be exceeded for the head of the screw to reach the position. This non-return element could of course be provided in the other figures.

Returning to the previous figures, particularly to FIGS. 3 and 4, it is seen that the drilling 12A′ of the first clamping end 12A through which the clamping rod passes can be oblong, so as to allow the displacement of this rod relative to the first clamping end, when clamping the clamping device. The different constituent elements of the belt can be made from flat metal bands. Particularly, in the region in which it cooperates with the connecting piece 26, the first clamping end 12A forms a flat band which, once the connecting piece is pre-hooked on it, constitutes a wall element opposite to the bottom wall 27C of this connecting piece.

The second clamping end of the belt 11A has, as has been said, a drilling 11A′ allowing the passage of the clamping rod. This drilling 11A′ can also be oblong to allow the displacement of the rod relative to this second end. In this case, the belt portion 11 is formed in a band, particularly a metal band and this second clamping end 11A can be locally reinforced. To do so, a free end portion of the band in which the belt part 11 is constituted is folded back on itself and is folded down so as to provide the end 11A with a double thickness in which the opening 11A′ is made.

Moreover, in this area, this end 11A forms a concave lug for housing a spacer 32 at the rear of which the nut 14B is located. This spacer has a passage 32A through which the clamping rod 14 can pass. The spacer can be formed from a metal band wound on itself and cut locally to form the passage 32A. In this case, the spacer 32 has an outer cradle shape with a convexity matching the concavity formed on the outer face of the clamping end 11A. Means for retaining and locking the spacer in rotation relative to this first end can be provided. In this case, the edge of the passage 32A has legs 34 folded back so as to project beyond the front face of the spacer, turned towards the outer face of the clamping end 11A. These legs 34 are thus placed in the opening 11A′ so as to cooperate with the edge of this opening to wedge the spacer relative to them. The spacer 32 can be hollow, while being formed in a band wound on itself. In this case, the joint plane of the ends of this band is formed on the front face of the spacer, the legs 34 are made on the edges of this joint plane. The front opening of the passage 32A formed in the front face of the spacer is therefore formed by a cutout 33 in the edges of the band in which the spacer is formed. On the other hand, the rear opening of the passage 32A located in the rear face of the spacer can be formed by a circular or ovalized cutout 33′.

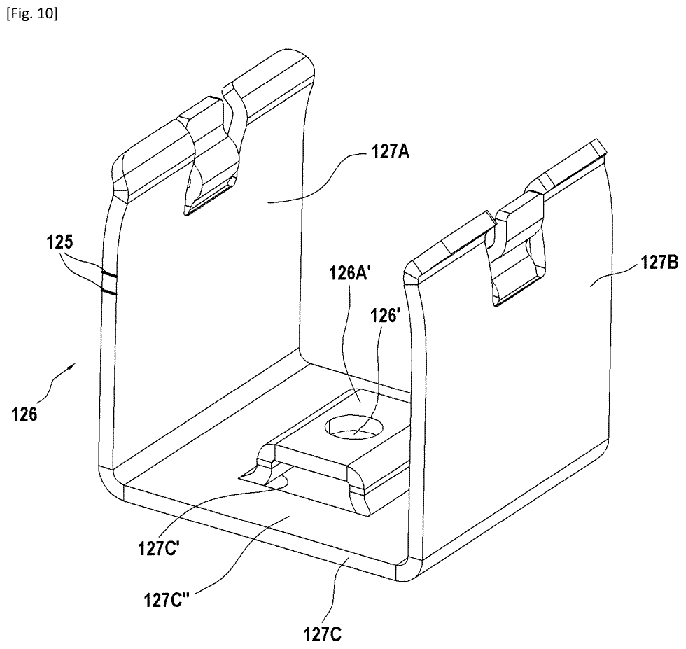

FIG. 10 which illustrates one variant of embodiment for the connecting piece is now described. In this figure, the same references as in the previous figures are used, increased by 100 to designate the connecting piece and its different elements.

The connecting piece 126 also has a U shape, with a bottom wall 127C and two side walls 127A and 127B. Like the connecting piece 26, it forms a cage part for the spring. The connecting piece 126 is distinguished from the connecting piece 26 by two aspects, namely, on the one hand, a conformation slightly different from its bottom wall and, on the other hand, the presence of particular visual marks for the mark threshold.

Regarding the bottom wall 127C, the spring centering portion is formed by an advanced portion 126A′ which has a drilling 126′ for the clamping rod. In this case, this advanced portion 126A′ is formed in a central portion of the bottom wall 127C all around which the rest of the bottom wall remains. Thus, the part of the bottom wall which is not advanced is present not only between the advanced portion 126A′ and the side walls 127A, 127B as in the example of the previous figures, but also on the sides of the advanced portion, by marginal portions 127C″ which extend, on either side of the advanced portion 126A′, from one of the side walls 127A, 127B to the other. Here, the advanced portion is separated from these marginal portions 127C″ by cutouts in the bottom wall and is pushed back, for example by stamping, in order to be advanced. The edges of the cutout or the axial wall elements 127C′ of the outer surface of the advanced portion 126A′ can serve as anti-rotation members for the clamping rod, particularly when, as in the example represented, these wall edges or elements have flats.

Of course, it is possible to make the advanced portion by a stamped part without cutouts on its sides but pierced at its bottom to allow the passage of the clamping rod. The geometry of this stamped part or its dimensions can then make it possible to achieve an anti-rotation function of the clamping rod. For example, the outer surface of the stamped part may have one or several flats or locally define transverse dimensions requiring forceful engagement of the head of the clamping rod in the stamped part.

Regarding the visual marks, the connecting piece 126 has at least a line, a notch or the like, present on at least one of the side walls 127A, 127B, in this case on its section, this line, notch or the like forming a visual mark. The operator checking the clamping of the belt can thus check that the first clamping end 12A has reached the level of the visual mark(s). For example, two visual marks 125 spaced apart by a distance corresponding to the band thickness of the first clamping end can be provided. Of course, such visual marks can be provided on the connecting piece 26 previously described.

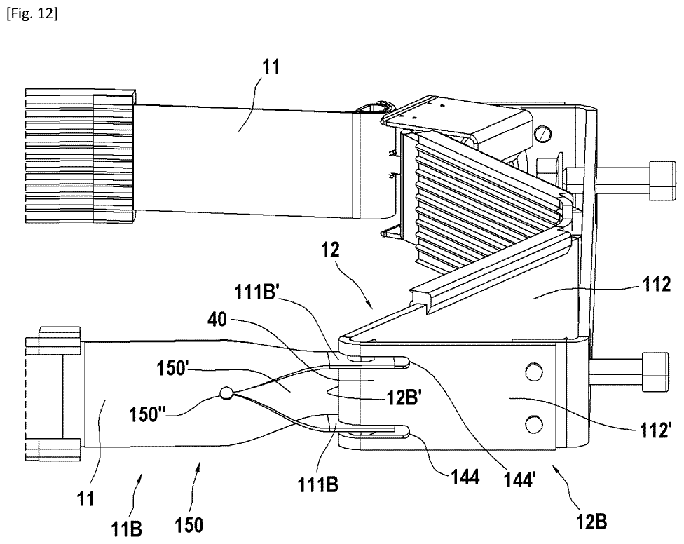

FIG. 12 shows another variant which relates on the one hand to the clamping threshold and, on the other hand, to the visual mark of this threshold.

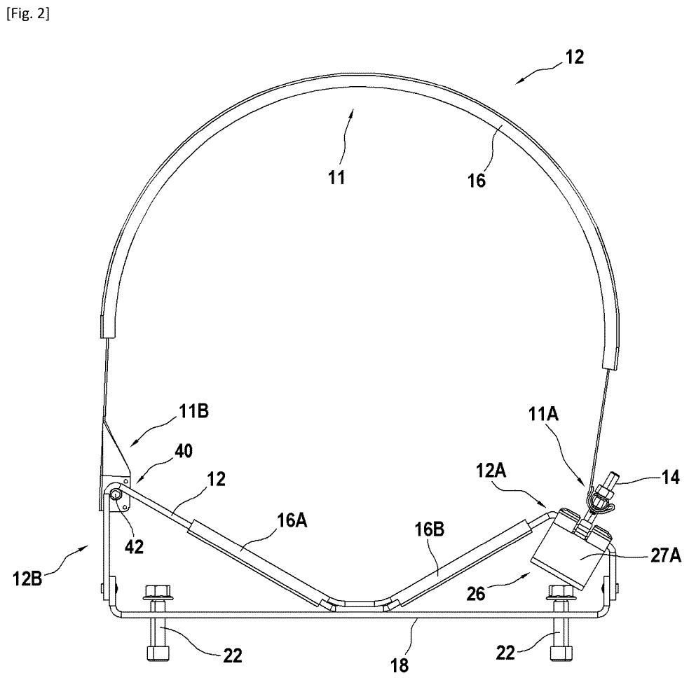

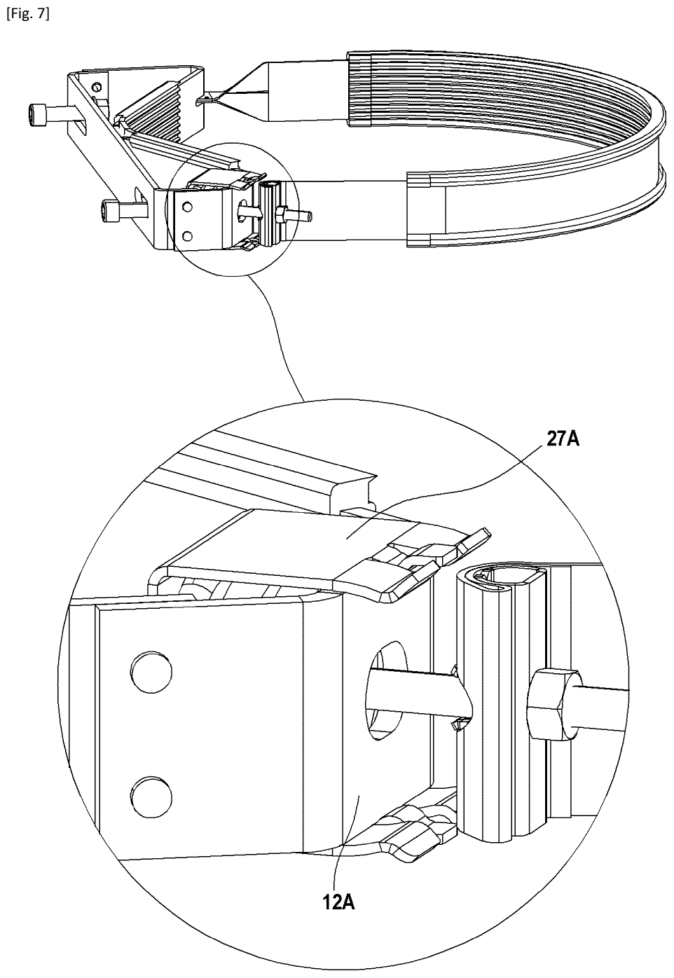

In FIG. 12, the same references as in FIGS. 1 to 9 are used, increased by 200 to designate the elements of the connecting piece. For the sake of simplification, FIG. 12 only shows one of the side walls 227A of the connecting piece. The two side walls of the connecting piece are similar to each other and the bottom wall of the latter can be similar to that of the connecting piece 26 or to that of the connecting piece 126.

In the preceding figures, two inner protrusions 29A and 29B, in this case formed by corrugations, are provided on the side wall 27A and the connecting piece is held in the waiting position at the first clamping end 12A by the positioning of this first end between these two protrusions, then the clamping threshold is reached when the positioning of this first end exceeds the protrusion 29A towards the bottom wall of the connecting piece. Here, the clamping threshold position is therefore very close to the waiting position.

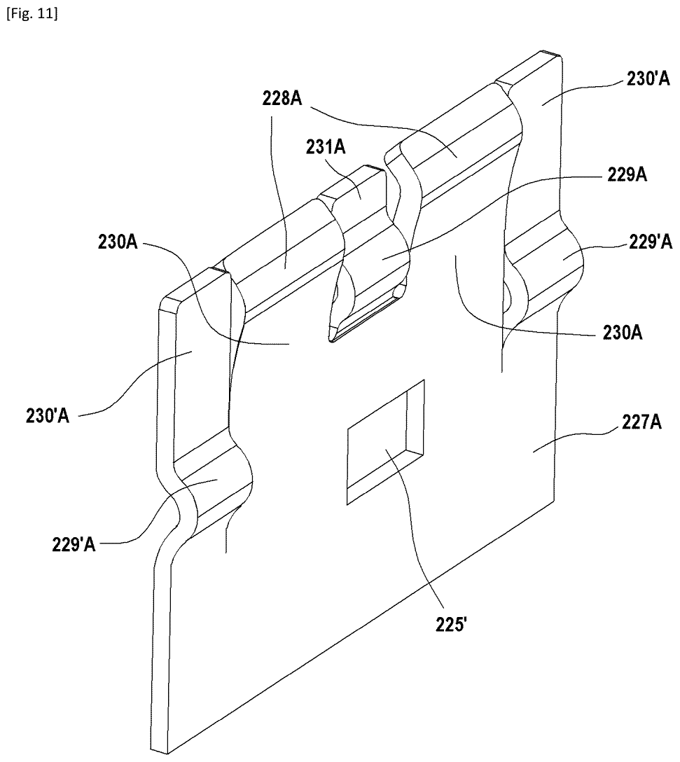

It may be necessary to have greater clamping amplitude from the pre-mounted position, which implies that the amplitude of the movement of the connecting piece relative to the first clamping end is greater. Thus, in FIG. 11, it is a third protrusion 229′A that defines the clamping threshold. The side wall 227A therefore has two protrusions 228A and 229A respectively similar to the protrusions 28A and 29A and positioned so as to define therebetween the retaining position of the connecting piece, and a third protrusion 229′A, located closer to the bottom (to the retaining wall) than the second protrusion 229A, and it is when, due to the movement of the connecting piece under the effect of the clamping, the first clamping end 12A exceeds this third protrusion, that the clamping threshold is reached. Here, the protrusions 228A, 229A and 229′A are formed by corrugations inwardly of the connecting piece, like the protrusions of the previous example. In this case, these protrusions are present on distinct legs and two marginal legs 230′A each provided with a corrugation 229′A, two intermediate legs 230A each provided with a corrugation 228A and a central leg 231A provided with the corrugation 229A are represented. However, a different number of legs and, for example, making the corrugations 229A and 229′A or the corrugations 228A and 229′A on the same leg, could be provided.

Moreover, FIG. 12 shows another variant of visual mark of a clamping threshold. In this case it is a window 225′ made in the side wall 227A and allowing the operator to check from outside the connecting piece that the first clamping end 12A has reached the clamping threshold position, in this case defined by the passage behind the corrugations 229′A.

Of course, the variant which has just been described with reference to FIG. 12 can be implemented for the connecting piece 26 or 126.

Another aspect of the disclosure which relates to the hinge between the two belt parts 11 and 12 will now be described. The second end 12B of the second belt part 12 has a retaining area 40 relative to which the second end 11B of the first belt part is pivotally retained by a pivot axis 42.

This is particularly visible in FIGS. 1, 2, 6 and 8. In this case, the retaining area 40 comprises a slot 44 into which the second end 11B of the first belt part 11 is inserted. In this case, this retaining area also has a folding and therefore provides, on the outer face of the second belt part 12, a bearing for the rotation of the pivot axis 42. Two portions of the second end of the second belt part can thus be distinguished on either side of the folded area 12B′, these two portions being respectively identified 112 and 112′ in FIG. 8. In this case, due to the folding in 12B′, these two portions are inclined relative to each other by forming therebetween an angle of the order of 60º. This angle could be different, but it is preferably less than 90°, for example of the order of 40° to 70°. The slot 44 extends into these two portions 112 and 112′ so as to allow the free pivoting of the second end 11B of the first belt part 11 relative thereto. Indeed, depending on the pivot angle, the free end portion 11B′ of this first end comes out of the slot, in either of the portions 112 and 112′.

The slot 44 into which the end 11B of the first belt part 11 is inserted is oriented perpendicularly to the general orientation of the first belt part 11 in its current part (the current part being the one that can come into clamping contact with the object to be clamped). Indeed, the direction of the width of this slot, in which its smallest dimension is noted, is transverse relative to the general orientation of the band portions that constitute the first and second belt parts.

The first belt part 11 has a twist area 50 (see FIG. 6) bringing the second end 11B of the first belt part 11 substantially at right angles to a current part of this first belt part. In other words, the band portions forming the first belt part are oriented substantially at right angles to each other, on either side of the twist area 50. The pivot axis 42 is for its part perpendicular to the second end 11B of the first belt part which is inserted into the slot 44. As can be seen in particular in FIG. 6, the pivot axis 42 is engaged in a drilling 43 of the second end 11B of the first belt part, this drilling being made in the free end portion 11B′ which is located on the other side of the twist area 50 relative to the second end 12B of the second belt part 12.

In this case, the second end 11B of the first belt part has a longitudinal fold 51 according to which two band halves 51A and 51B of the first belt part 11 are brought against each other. This fold 51 extends from the twist area 50 to the free end of the second end 11B of the first belt part 11. Thus, in its area inserted into the slot 44, this end 11B has a double thickness formed by the band portions 51A and 51B brought against each other. The mechanical resistance is thus locally increased, in particular for the retention of the axis 42 in the aforementioned drilling 43.

As seen in FIG. 6, it can be provided to keep these two band halves 51A and 51B pressed against each other by retaining means such as welding or clinching. For example, welding or clinching points 54 are represented in FIG. 6 by extending on either side of the slot 44 once the end portion 11B′ is inserted into this slot 44. To delimit the twist area 50 and prevent this twist area, under the effect of the clamping tensile forces, from propagating in the current part of the first belt part 11, the latter can have a boss 56 located on the other side of the twist area 50 relative to its second end 11B. In a way, this boss 56 forms a stop to the twist. In this case it extends transversely from one side to the other over the width of the band in which the first belt part 11 is formed. However, the boss could be more localized and simply interfere with the end of the fold 51 opposite to the free end of the first belt part. The pivot axis 42 can be forcefully engaged in the opening 43 so as to remain in position in this opening.

Of course, this hinge can be implemented independently of the aspects which have been described concerning the first ends 11A and 12A of the belt, particularly relating to the connecting piece 26 and to the spring 24. It is noted that the hinge thus made is particularly mechanically resistant. It is located in a region of the belt which is not intended to be directly in contact with the object clamped by this belt, the contact areas being in this case defined by the sheaths 16, 16A and 16B which have been described. Thus, the twist area has no negative impact on the quality of the clamping and does not risk damaging the clamped object.

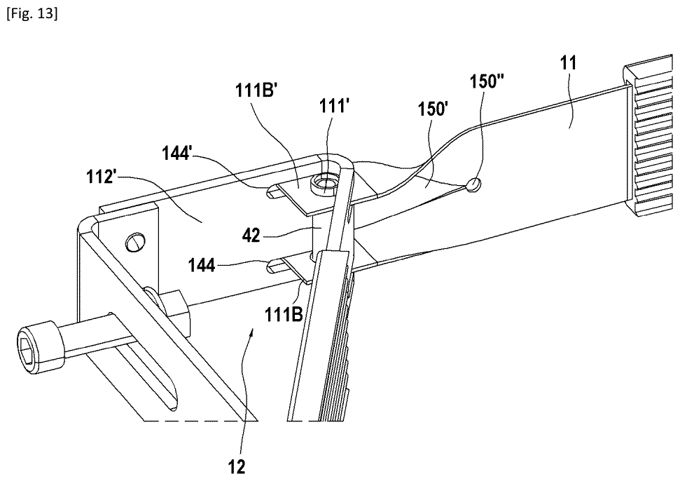

FIGS. 12 and 13 show a variant for the hinge between the two belt parts 11 and 12. Here, the retaining area 40 of the second end 12B of the second belt part 12 comprises two slots 144 and 144′ which extend into the portions 112 and 112′ of the folded area 12B′, and the second end 11B of the first belt portion 11 has two parallel end legs 111B and 111B′ respectively inserted into the slots.

The slots 144 and 144′ are parallel to each other and are oriented perpendicularly to the general orientation of the first belt part 11 in its current part.

The first belt part 11 has a twist area 150 and a longitudinal cutout 150′. The cutout 150′ separates the end portion of the end 11B into the two legs 111B and 111B′. This cutout 150′ extends from the free end of the end 11B to a stopping point 150″. This stopping point can have a conformation aimed at avoiding the propagation of the cutout 150′ under the effect of the clamping tension, this conformation being for example a small circular cutout and/or a stamping or a local work hardening.

The twist area 150 is formed between the stopping point 150″ and the free end of the end 11B and comprises two twists respectively made on each of the legs 111B and 111B′ to bring each of these legs substantially at right angles to the current part of the first belt part 11. The pivot axis 42 is for its part perpendicular to the ends of the legs 111B and 111B′ engaged in the slots 144 and 144′ and is engaged in drillings of these ends.

It is seen in FIG. 13 that these drillings can have flanges 111′ formed by the edges of the drillings of the legs 111B and 111B′ pushed back laterally, that is to say parallel to the pivot axis 42, for example outwards. These flanges locally increase the mechanical resistance to forces.

A similar flange can also be present on the edge of the drilling 43 in FIG. 6.

This variant for the hinge can also be implemented independently of the aspects which have been described concerning the first ends 11A and 12A of the belt, particularly relating to the connecting piece and to the spring.

1. A device for clamping an object, comprising a belt with at least a first and a second clamping end and a clamping member which connects the two clamping ends while being retained by relative to them so that the clamping of the clamping member moves the first and second clamping ends relative to each other so as to tighten the belt, the clamping member being retained relative to at least the first clamping end via a spring and a connecting piece, so that the clamping of the clamping member tends to move the connecting piece relative to the first clamping end against the elastic return of the spring, the connecting piece being able to occupy, relative to the first clamping end, a waiting position in which it holds the spring with respect to the first clamping end.

2. The device according to claim 1, comprising a member for holding the connecting piece in the waiting position, particularly a waiting clipping member.

3. The device according to claim 1, wherein the connecting piece is configured to occupy a clamping threshold position which is reached by the clamping of the clamping member.

4. The device according to claim 3, comprising a threshold mark to note that the clamping threshold position has been reached, the threshold mark particularly comprising a threshold clipping member.

5. The device according to claim 1, wherein the connecting piece is able to occupy a maximum clamping limit position, the device optionally comprising a maximum clamping stop.

6. The device according to claim 1, wherein the connecting piece forms a cage part in which the spring is disposed, the connecting piece optionally having a portion for centering the spring.

7. The device according to claim 6, wherein the clamping member comprises a clamping rod and the cage part formed by the connecting piece has a retaining surface against which an element for retaining the clamping rod, such as a head of said rod, is retained, said retaining surface optionally comprising an anti-rotation member of the clamping rod and being optionally located on an outer face of the spring centering portion.

8. The device according to claim 2, wherein the connecting piece has a U shape with two branches, the connecting piece being plugged onto the first clamping end so that this first clamping end passes between the two branches, the member for holding the connecting piece in the waiting position comprising at least one holding protrusion protruding on the inner face of at least one of the two branches.

9. The device according to claim 4, wherein the connecting piece has a U shape with two branches, the connecting piece being plugged onto the first clamping end so that this first clamping end passes between the two branches, the threshold mark comprising a mark protrusion protruding on the inner face of at least the one of the two branches.

10. The device according to claim 5, wherein the connecting piece has a U shape with two branches, the connecting piece being plugged onto the first clamping end so that this first clamping end passes between the two branches, at least one of the two branches having a maximum clamping stop protrusion.

11. The device according to claim 1, wherein the clamping member comprises a clamping rod which is retained relative to the second clamping end of the belt by a nut.

12. The device according to claim 1, wherein the belt comprises a first belt part whose first end forms one of the first and second clamping ends and a second belt part whose first end forms the other of the first and second clamping ends, said second belt part forming a fixing part configured to be fixed on a support.

13. A device for clamping an object, comprising a belt with at least a first and a second clamping end and a clamping member which connects the two clamping ends while being retained by relative to them so that the clamping of the clamping member moves the first and second clamping ends relative to each other so as to tighten the belt, the belt comprising a first belt part having a first end which forms one of the first and second clamping ends and a second belt part having a first end which forms the other of the first and second clamping ends, the first and second belt parts having second ends which are connected by a hinge, the second end of the second belt part having a retaining area, relative to which the second end of the first part belt is pivotally retained by a pivot axis.

14. A device according to claim 13, wherein the retaining area comprises a slot into which the second end of the first belt part is inserted.

15. The device according to claim 14, wherein the first belt part has a twist area bringing the second end of the first belt part substantially at right angles to a current part of the first belt part, the pivot axis being perpendicular to said second end of the first belt part.

16. The device according to claim 15, wherein the pivot axis is engaged in a drilling of the second end of the first belt part, this drilling optionally having a flange.

17. The device according to claim 15, wherein the second end of the first belt part has a longitudinal fold according to which two band halves of the first belt part are brought against each other, by being optionally kept pressed against each other, for example by welding or clinching.

18. The device according to claim 15, wherein the first belt part has a boss located on another side of the twist area relative to the second end of the first belt part.

19. The device according to claim 13, wherein the second end of the first belt part has two parallel legs each inserted into a slot of the retaining area.

20. The device according to claim 19, wherein the two parallel legs are separated by a cutout and the second end of the first belt part has a twist area comprising two twists bringing each of the legs substantially at right angles to a current part of the first belt part.
